(19) United States
(12) Patent Application Publication
(10) Pub. No.: US 2022/0198140 A1
(43) Pub. Date: Jun. 23, 2022

(54) LIVE AUDIO ADJUSTMENT BASED ON SPEAKER ATTRIBUTES

(71) Applicant: International Business Machines Corporation, Armonk, NY (US)

(72) Inventors: Craig M. Trim, Ventura, CA (US); Melissa Restrepo Conde, Leland, NC (US); Shikhar Kwatra, San Jose, CA (US); Aaron K. Baughman, Cary, NC (US)

(21) Appl. No.: 17/128,282

(22) Filed: Dec. 21, 2020

(51) Int. Cl. G06F 40/263; G06F 40/56; G10L 17/02

(52) U.S. Cl. CPC G06F 40/263; G10L 17/02; G06F 40/56

(57) ABSTRACT

An audio stream of a speaker can be isolated from a received audio signal. Based on the audio stream, an attribute of the speaker can be identified. This attribute can be presented to a user, allowing for a user input. Based on a received user input (and on the audio stream), the audio stream can be modified.

### BACKGROUND

Ongoing globalization is leading to the world becoming increasingly interconnected, resulting in communication between different cultures (including with multiple languages) becoming more commonplace. Multilingualism is similarly increasing. Thus, broadcasts of a speaker giving a speech in a first language overlaid with audio of a translator's speech are becoming more and more common.

When a user device, such as a desktop computer, plays sound, this generally involves the user device sending an audio signal to one or more audio output devices (such as headphones).

An audio signal may be divided into (or assembled from) multiple component “audio streams.” For example, a first audio stream of a person talking can be combined with a second audio stream of a dog barking into an audio signal, which may then be played back.

Most user devices also enable at least some form of control over the playback, such as a “master” volume control to adjust the amplitude of playback. For example, when streaming a broadcast over the internet, a user device typically receives an incoming audio signal from an external source and causes an output device to emit sound based on the audio signal. Between receiving the incoming signal and playing back sound, the user device can exert some control over the incoming audio signal, such as a “master” volume adjustment. If the broadcast is of two people speaking amidst background noise, increasing the master volume typically increases the volume of the people's speech as well as the background noise.

### SUMMARY

Some embodiments of the present disclosure can be illustrated as a method. The method comprises receiving an audio signal. The method further comprises isolating an audio stream of a speaker from the signal. The method further comprises identifying an attribute of the speaker based on the audio stream. The method further comprises presenting the attribute to a user. The method further comprises modifying the audio stream based on a user input.

Some embodiments of the present disclosure can also be illustrated as a computer program product comprising a computer readable storage medium having program instructions embodied therewith, the program instructions executable by a computer to cause the computer to perform the method discussed above.

Some embodiments of the present disclosure can be illustrated as a system. The system may comprise memory and a central processing unit (CPU). The CPU may be configured to execute instructions to perform the method discussed above.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure. Features and advantages of various embodiments of the claimed subject matter will become apparent as the following Detailed Description proceeds, and upon reference to the drawings, in which like numerals indicate like parts, and in which:

FIG. 1 is a high-level media playback adjustment method based on speaker attributes, consistent with several embodiments of the present disclosure.

FIG. 2 is a diagram of an example user interface (UI) enabling a user to control playback based on speaker attributes, consistent with several embodiments of the present disclosure.

FIG. 3 is an example method of identifying a speaker of a given audio stream based on language, consistent with several embodiments of the present disclosure.

FIG. 4 illustrates a high-level block diagram of an example computer system that may be used in implementing embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to systems and methods to adjust audio playback based on speaker attributes. More particular aspects relate to a system to receive an audio signal, isolate an audio stream of a speaker from the audio signal, determine an attribute of the speaker, present the speaker and attribute to a user, and modify playback of the audio signal based on the audio stream and a user input.

Throughout this disclosure, distinction is made between “audio signal” and “audio streams.” As used herein, an “audio signal” refers to a signal received and interpreted by a system to produce audio playback. For example, an audio signal may be a recording of a person speaking amidst background noise.

An audio signal may be divided into multiple “audio streams.” Continuing with the previous example, a portion of the audio signal comprising the person's speech may be isolated from the remainder of the audio signal (i.e., the background noise). This isolated portion of the person's speech may be referred to as that person's audio stream. Similarly, if multiple people are speaking in the recording, each speaker may be associated with a distinct audio stream. As a result, a recording of two speakers talking in a room amidst background noise may be referred to herein as including three audio streams: an audio stream of the first speaker, an audio stream of the second speaker, and an audio stream of the background noise. In some instances, however, the recording may instead be divided into two audio streams; an audio stream of the first speaker and an audio stream of the second speaker, where both audio streams would include background noise.

In some instances, component audio streams may be recorded separately and “mixed” (combined) into the resulting audio signal. In other instances, an audio signal may be recorded as a single stream. Notably, even if an audio signal is composed via mixing multiple component audio streams, it may still be transmitted as a single audio stream (for example, information identifying various component audio streams may be omitted).

A user listening to the recording will generally be presented with playback of the audio signal. While typical devices at least enable “master” volume controls and/or “mute” functionality, an incoming audio signal can also be preconfigured (by some external system) to enable finer playback control. For example, the incoming audio signal may include information describing multiple distinct audio streams contained within the incoming audio signal. While this can allow the user device to, in some cases, adjust volume levels of one person's speech independently of another person's speech, preconfiguring an audio signal generally requires specialized equipment (e.g., multiple microphones, mixing equipment, etc.), at least some of which being utilized “upstream” of receipt of the audio signal. In other words, existing user devices have little control over whether they have access to component audio streams of a received audio signal; either the system transmitting the signal preconfigured it to enable the user device to control them, or it did not. Further, in practice, audio signals are frequently received in a “monolithic” fashion (i.e., without any information describing any component audio streams), so if a user wishes to adjust or otherwise control playback, options may be relatively limited.

Systems and methods consistent with the present disclosure enable isolation of audio streams from an audio signal, identification of attributes associated with the audio streams, and control of audio playback based on various speaker attributes. As an example, a system may receive an audio signal including a first speaker and a second speaker. The system may analyze the audio signal (such as by comparing amplitude and frequency of the signal over time) to isolate audio streams of each speaker. The system may then analyze an audio stream to determine an attribute of the associated speaker (or of the audio stream itself). Example attributes can include tone (such as aggressive, sarcastic, etc.), a language the speaker is using, etc.

For example, the system may utilize a speech-to-text algorithm to transcribe the first speaker's audio stream into a transcript (i.e., text), then utilize Natural Language Processing (NLP) on the resultant transcript to determine which language the first speaker is using. The system may then perform similar analysis on the audio stream associated with the second speaker.

The system can then present options to a user via a user interface (UI) to enable a user to control playback of the overall audio signal on a per-audio-stream basis; for example, the user may selectively mute the second speaker and/or enable subtitles for the second speaker. Further, a user may adjust the volume of all speech in a first language (but leave speech in the second language unchanged). The system may modify the audio signal before playback based on the user input, for example to adjust a volume level of a component audio stream of the audio signal.

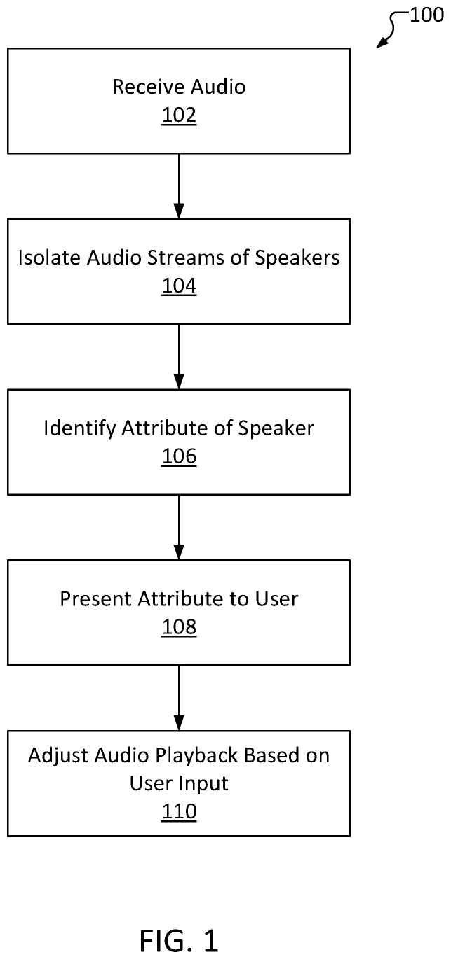

FIG. 1 is a high-level media playback adjustment method 100 based on speaker attributes, consistent with several embodiments of the present disclosure. Method 100 may be performed by, for example, a user device (such as a computer, mobile device, etc.). Method 100 comprises receiving an audio signal at operation 102. The audio signal may be received from an external device or system via one or more networks or cables (such as over the internet). The audio signal may be an analog signal or a digital audio signal. The audio signal may be a part of an overall media signal (such as a video broadcast).

Notably, the audio signal received at operation 102 may be received as a single audio stream. This may be due to multiple independent causes. As a first example, the audio signal may be received as a single audio stream because of how the audio signal was initially recorded/mixed. For example, the audio signal may have been recorded via a single microphone by a system that was not capable of identifying component audio streams. As a second example, the audio signal may be received as a single audio stream because of how the audio signal was transmitted. For example, even if an audio signal was initially recorded/mixed in a manner to include information identifying multiple component audio streams, that information may have been omitted or otherwise lost when the audio signal was transmitted, and thus may be absent when the audio signal is received at operation 102. As a third example, the audio signal may be received as a single audio stream due to capabilities or configuration of the device receiving the signal. For example, a format mismatch may result in parts of a received signal being omitted. As an illustrative example, the audio signal may have been formatted according to first format, transmitted, and received at operation 102 by a user device. If the user device is configured to receive audio signals according to a second format, the resulting mismatch could result in lost information, such as information identifying component audio streams.

Method 100 further comprises isolating audio streams of speakers at operation 104. Operation 104 may include, for example, leveraging one or more existing techniques such as Mel-Frequency Cepstral Coefficient (MFCC) analysis, a Gaussian Mixture Model (GMM), etc. For example, if the audio signal received at operation 102 includes a recording of two people speaking, operation 104 may include isolating a first portion (stream) of the audio signal corresponding to the first person's speech from a second portion of the audio signal corresponding to the second person's speech. In general, operation 104 includes detecting speech (i.e., one or more spoken words) during the audio signal and identifying a number of speakers of the detected speech. Notably, operation 104 may include identifying the speaker(s) using simple anonymous identifiers (e.g., “speaker 1,” “speaker 2,” and so on). As a result of operation 104, an isolated audio stream may include speech from a single speaker (even if, in the overall audio signal, a second speaker was also speaking at the same time as the first speaker). Thus, a recording of two people talking simultaneously can be isolated into a first audio stream of the first person's speech and a second audio stream of the second person's speech.

Operation 104 may also be performed repeatedly as the audio signal is received/processed; for example, an audio signal may be streamed in real-time. In such a situation, the incoming audio may be “sorted” via operation 104. For example, as audio is received, operation 104 may include determining whether the audio includes speech. If it does, then operation 104 may further include determining, for each “known” speaker, a degree of confidence that the speech was uttered by the speaker. When the degree of confidence for a given speaker is above a threshold, that speech may be “assigned” (sorted) to the audio stream corresponding to the speaker. If the degree of confidence is below the threshold for all known speakers, the speech may be assigned to a new speaker audio stream, a “background” audio stream, an “uncategorized” audio stream, or the like. Thus, systems and methods consistent with the present disclosure may be capable of determining that an audio stream is not being spoken by either of two “known” speakers, thus concluding that a new third speaker is the most likely option.

Method 100 further comprises identifying an attribute of a speaker at operation 106. Attributes can be traits of the speaker or the speaker's voice that can be recognized by the system and easily communicated to a user to help the user identify which attribute corresponds to which speaker. The attribute identified at operation 106 may include, for example, a language that the speaker is speaking, an accent of the speaker's voice, whether the speaker's voice is particularly loud/quiet, whether the speaker's voice is particularly high-pitched or low-pitched, whether the speaker is speaking particularly rapidly/slowly, whether the speaker's voice is particularly clear/muffled, etc. These attributes, when identified, can be included in the speaker's identity (expanding upon “speaker 1” and “speaker 2”).

Operation 106 may include, for example, performing speech-to-text analysis on the audio stream of the speaker (isolated at operation 104), resulting in transcribed text of what the speaker has said. Continuing with the “language” example, operation 106 may further include performing feature matching on the text (i.e., comparing features of the transcribed text to known features of various languages) via Natural Language Processing (NLP). Thus, a system performing method 100 may determine that a first speaker is speaking a first language (e.g., French).

Once identified, attributes may be associated with a speaker, such as by “tagging” the speaker as having spoken with the relevant attributes. Further, attributes can be associated with the speech itself as well as the audio stream itself. Using “clarity” as an illustrative example of an “attribute,” a first speech segment (uttered by a first speaker in a first audio stream) such as a word, phrase, sentence, etc., may be detected to be muffled. This may result in tagging the first speaker as speaking in a muffled voice, tagging the first speech segment as muffled, and/or tagging the first audio stream as including muffled speech. A second speech segment (also uttered by the first speaker in the first audio stream) may be detected to be clear. This may result in revising the “muffled” tag for the first speaker to a “mixed” tag (indicating that the first speaker has uttered both muffled and clear speech), tagging the second speech segment as clear, and/or tagging the first audio stream as including clear speech (i.e., in addition to including muffled speech). Some or all of these forms of association/tagging may be implemented, depending upon embodiment/use case. Further, other attributes may be detected and tracked in addition to (or instead of) clarity, such as language, pitch, etc. This advantageously enables flexible control over playback of an audio signal based on various attributes.

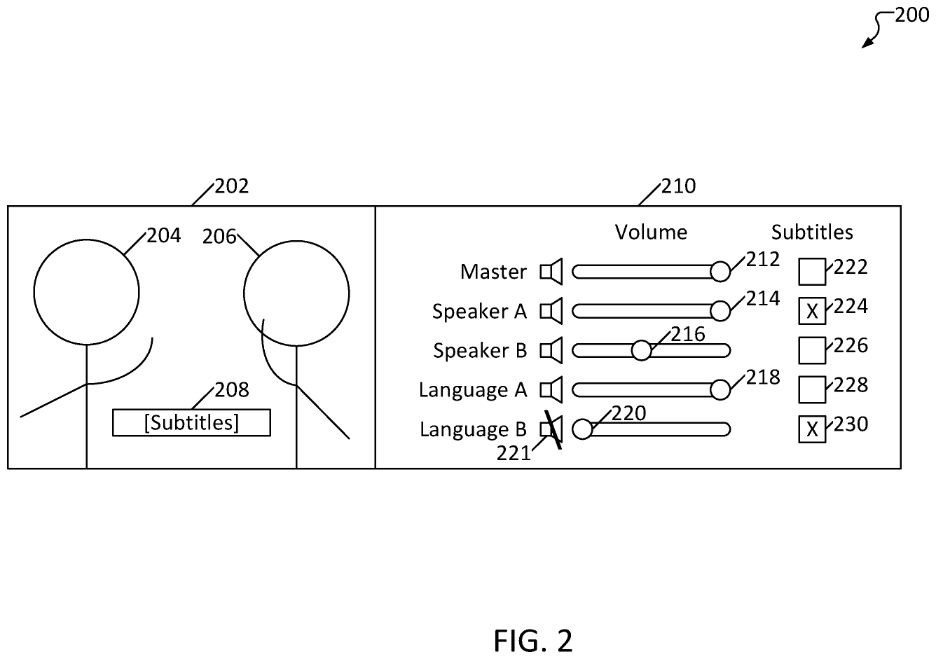

Method 100 further comprises presenting the attributes to a user at operation 108. Operation 108 may include, for example, providing a user interface (UI) during or prior to playback of the audio signal. The UI may list detected attributes in the audio signal. In some use cases, the UI may also list detected speakers. The UI may be configured to enable the user to adjust playback of the audio signal based on the detected attributes/speakers. Other options may also be provided (e.g., subtitles). An example UI is depicted in FIG. 2, discussed below.

Method 100 further comprises modifying the audio signal based on user input at operation 110. Operation 110 may include, for example, reducing or increasing volume of one or more audio streams based on a user's input. As an example, multiple audio streams may be isolated from an input audio signal. A first attribute of a first speaker may be detected in a first audio stream of the audio signal (for example, the first speaker may be detected to be speaking in French, or first speaker may be detected to be muffled).

A user may be enabled, via a UI provided at operation 108, to control volume of the audio signal on a “speaker” basis, an “attribute” basis, or combinations thereof. For example, a user who wishes to reduce volume of all speech spoken by the first speaker may do so by opting, via the UI provided at operation 108, to reduce volume of the first audio stream. Similarly, the user may opt, via the UI provided at operation 108, to reduce volume of all speech associated with the first attribute (e.g., all French speech, all muffled speech, etc.). Further, a user may decide to reduce volume of only speech associated with the first attribute spoken by the first speaker; as an illustrative example, the first speaker's French speech may be reduced in volume, but the first speaker's English speech is not reduced in volume, and a second speaker's speech (regardless of language) is not reduced in volume. Of course, the volume may be reduced to zero (i.e., muted) or set to an intermediate level (such as, for example, 33%, 50%, etc.). Other adjustments besides volume reduction are also fully considered, such as enabling/disabling captioning, volume increases, etc.

Operation 110 may then include reducing volume of the first audio stream based on the user's input and “reassembling” the audio streams into a modified audio signal. Thus, when played back, the modified audio signal will sound similar to the input audio signal, except speech tagged with the first attribute (e.g., the first speaker's French speech) will be reduced in volume.

FIG. 2 is a diagram 200 depicting an example user interface (UI) 210 enabling a user to control playback based on speaker attributes, consistent with several embodiments of the present disclosure. Diagram 200 includes video feed 202, depicting first speaker 204 and second speaker 206. Depending upon user configuration, video feed 202 may also include subtitles 208, depicting transcripts of what one or both of speakers 204/206 are saying. Embodiments lacking a video component (i.e., audio-only, such as a radio broadcast, a podcast, an audio file, etc.) are also fully considered herein.

Diagram 200 also includes UI 210, including volume sliders (and labels describing each slider), subtitle checkboxes, etc. Speaker A may represent first speaker 204 while Speaker B may represent second speaker 206. Playback of an audio signal associated with video feed 202 may be modified based upon user inputs to UI 210. For example, “Master” volume slider 212, “Speaker A” volume slider 214, and “Language A” volume slider 218 are all at maximum, but “Speaker B” volume slider 216 is at half and “Language B” volume slider 220 is at zero (emphasized by the “Language B” speaker icon 221 being struck through). Thus, during playback, speaker A's speech will be twice as loud as speaker B's, except that any speech in Language B (regardless of which speaker is using Language B) will be entirely muted.

Further, subtitles 208 may be added, removed, or modified based on UI 210 as well. For example, “Master” subtitles checkbox 222, “Speaker B” subtitles checkbox 226, and “Language A” subtitles checkbox 228 are all disabled, while “Speaker A” subtitles checkbox 224 and “Language B” subtitles checkbox 230 are both enabled. Thus, all speech uttered by Speaker A is subtitled (regardless of language), and any of Speaker B's speech in Language B is be subtitled, but Speaker B's speech in Language A is not subtitled.

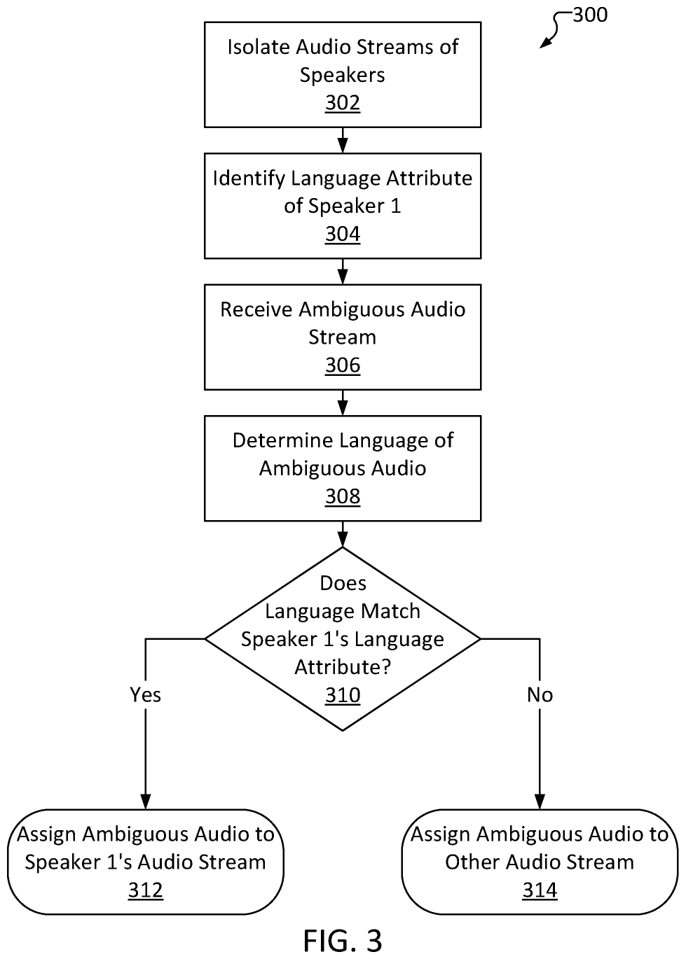

FIG. 3 is an example method 300 of identifying a speaker of a given audio stream based on language, consistent with several embodiments of the present disclosure. Method 300 may advantageously enable leveraging language information to assist in identifying a speaker of a given statement, particularly in conjunction with other speaker identification methodologies.

Method 300 comprises isolating audio streams of speakers from an audio signal at operation 302. Operation 302 may be performed in a substantially similar manner to operation 104 of method 100, as discussed with reference to FIG. 1, above. Operation 302 may result in a first audio stream of a first speaker's speech and a second audio stream of a second speaker's speech.

Method 300 further comprises identifying a language attribute of the first speaker (“Speaker 1”) at operation 304. Operation 304 may include, for example, performing pattern recognition on the first audio stream. In some instances, operation 304 may include transcribing the first speaker's speech (of a first audio stream) into text, then determining a language of the transcript. In some instances, operation 304 may be performed continuously (which may be useful, for example, in case speakers switch between languages). Operation 304 may further include determining a ratio of languages spoken by the first speaker. Operation 304 may be repeated for every identified speaker.

In some instances, a system performing method 300 may be unable to conclusively identify a speaker of a given segment of audio (e.g., a particular phrase, statement, word, etc.). Thus, method 300 further comprises receiving an ambiguous (i.e., unidentified) audio stream at operation 306. An audio stream being “ambiguous” effectively means a system is unable to determine which speaker uttered the stream; the ambiguous stream may be isolated from the audio signal at operation 302, but may have been spoken by the first speaker, the second speaker, or a new, third speaker. A new, third speaker's speech may not necessarily constitute an “unidentified” audio stream; as described above, systems and methods consistent with the present disclosure may be capable of conclusively determining (e.g., with a degree of confidence above a threshold) that an audio stream is not being spoken by either of two speakers, thus concluding that a new third speaker is the most likely option. This is considered distinct from an “unidentified” audio stream, which may correspond to a new speaker, but may also correspond to a previously identified speaker.

Method 300 further comprises determining a language of the ambiguous audio stream at operation 308. Operation 308 may be performed in a manner substantially similar to operation 304; the speech may be transcribed and then feature matched with known features of various languages to determine the most likely language.

Method 300 further comprises determining whether the language of the ambiguous audio stream matches the first speaker's language attribute at operation 310. Operation 310 may include, for example, determining whether the first speaker has spoken using the detected language more often than a threshold, more often than the second speaker, or both. As an example, if a first speaker exclusively speaks in Spanish while a second speaker switches between French and Spanish, if the unidentified audio stream is determined to be Spanish, operation 310 may determine that the detected language matches the first speaker's language attribute more than the second speaker's. If the first user has spoken using the detected language more than the second speaker (310 “Yes”), method 300 further comprises assigning the ambiguous audio stream to the first speaker's audio stream at operation 312. Thus, method 300 may enable use of language identification to improve confidence in speaker identification.

If the detected language does not match the first speaker's language attribute (310 “No”), method 300 further comprises assigning the ambiguous audio stream to another audio stream at operation 314. The other audio stream may be, for example, the second speaker's audio stream or a different “uncategorized” audio stream. For example, if the first speaker exclusively speaks in Spanish while a second speaker switches between French and Spanish, if the ambiguous audio stream is determined to be French, then the detected language may not match the first speaker's language attribute (310 “No”). In such an event, operation 314 may include assigning the ambiguous audio stream to the second speaker's audio stream.

Operation 314 may vary depending upon previous confidence of an identity of a speaker of the ambiguous audio stream. For example, if the ambiguous audio stream received at operation 306 is determined with near certainty to be either the first speaker or the second speaker, then operation 314 may include assigning the ambiguous audio stream to the second speaker's audio stream. However, if the ambiguous audio stream is determined to be any of the first speaker, the second speaker, or a new speaker, operation 314 may include assigning the ambiguous audio stream to an “uncategorized” or “background” audio stream.

As an additional example, if the first speaker rarely speaks in French and frequently speaks in Spanish, and the second speaker rarely speaks in French and frequently speaks in English, and the determined language of the ambiguous audio stream is French, the determined language may not match the first speaker's language attribute to a satisfactory degree (310 “No”). In this instance, operation 314 may include assigning the ambiguous audio stream to an “uncategorized” or “background” audio stream.

Operation 314 may vary depending upon use case. For example, in some use cases, a “best guess” may be preferable to leaving an ambiguous audio stream uncategorized. However, in some use cases, a failure to identify may be preferable to an educated guess. Since method 300 may not provide an absolute guarantee of speaker identity, it may not be preferable in all instances. Thus, in some embodiments, rather than attempting to identify a speaker of the ambiguous audio stream, a system may inform the user, via a user interface, that an ambiguous audio stream has been received. The system, via the user interface, may further inform the user of detected attributes (such as a language spoken by an unknown speaker of the ambiguous audio). The user interface may further enable the user to control playback of the ambiguous audio stream, similar to the controls described with reference to FIG. 2, above. In some instances, the system may inform the user of the “best guess” at identifying the speaker of the ambiguous audio stream.

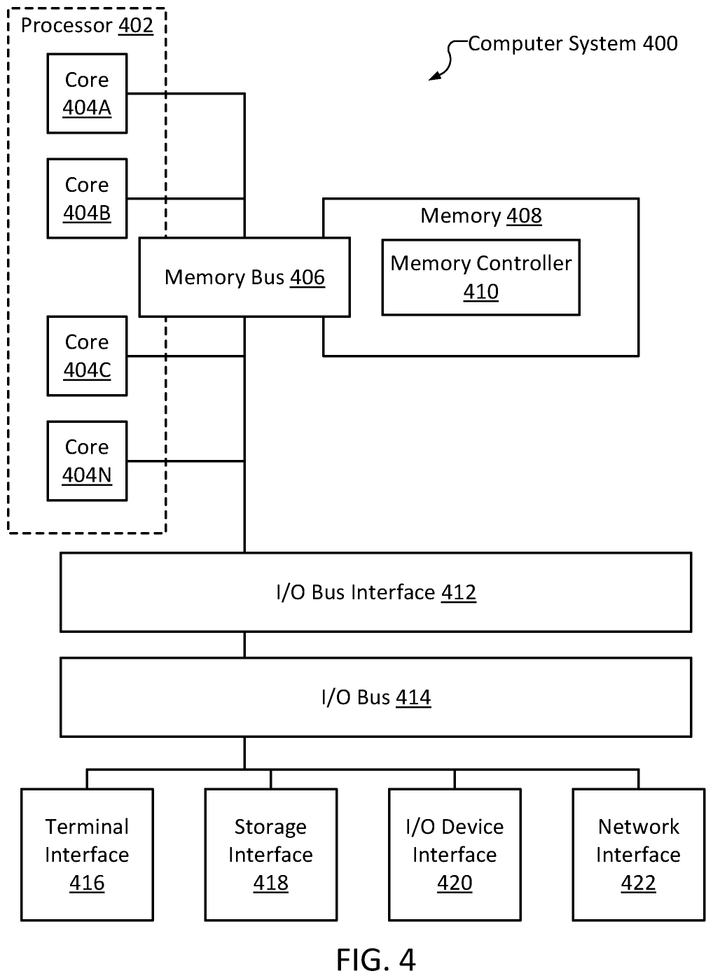

Referring now to FIG. 4, shown is a high-level block diagram of an example computer system 400 that may be configured to perform various aspects of the present disclosure, including, for example, methods 100 and 300. The example computer system 400 may be used in implementing one or more of the methods or modules, and any related functions or operations, described herein (e.g., using one or more processor circuits or computer processors of the computer), in accordance with embodiments of the present disclosure. In some embodiments, the major components of the computer system 400 may comprise one or more processors, such as a central processing unit (CPU) 402, a memory subsystem 408, a terminal interface 416, a storage interface 418, an I/O (Input/Output) device interface 420, and a network interface 422, all of which may be communicatively coupled, directly or indirectly, for inter-component communication via a memory bus 406, an I/O bus 414, and an I/O bus interface unit 412.

The computer system 400 may contain one or more general-purpose programmable central processing units (CPUs) 402, some or all of which may include one or more cores 404A, 404B, 404C, and 404D, herein generically referred to as the CPU 402. In some embodiments, the computer system 400 may contain multiple processors typical of a relatively large system; however, in other embodiments the computer system 400 may alternatively be a single CPU system. Each CPU 402 may execute instructions stored in the memory subsystem 408 on a CPU core 404 and may comprise one or more levels of on-board cache.

In some embodiments, the memory subsystem 408 may comprise a random-access semiconductor memory, storage device, or storage medium (either volatile or non-volatile) for storing data and programs. In some embodiments, the memory subsystem 408 may represent the entire virtual memory of the computer system 400 and may also include the virtual memory of other computer systems coupled to the computer system 400 or connected via a network. The memory subsystem 408 may be conceptually a single monolithic entity, but, in some embodiments, the memory subsystem 408 may be a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures. In some embodiments, the main memory or memory subsystem 804 may contain elements for control and flow of memory used by the CPU 402. This may include a memory controller 410.

Although the memory bus 406 is shown in FIG. 4 as a single bus structure providing a direct communication path among the CPU 402, the memory subsystem 408, and the I/O bus interface 412, the memory bus 406 may, in some embodiments, comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 412 and the I/O bus 414 are shown as single respective units, the computer system 400 may, in some embodiments, contain multiple I/O bus interface units 412, multiple I/O buses 414, or both. Further, while multiple I/O interface units are shown, which separate the I/O bus 414 from various communications paths running to the various I/O devices, in other embodiments some or all of the I/O devices may be connected directly to one or more system I/O buses.

In some embodiments, the computer system 400 may be a multi-user mainframe computer system, a single-user system, or a server computer or similar device that has little or no direct user interface but receives requests from other computer systems (clients). Further, in some embodiments, the computer system 400 may be implemented as a desktop computer, portable computer, laptop or notebook computer, tablet computer, pocket computer, telephone, smart phone, mobile device, or any other appropriate type of electronic device.

It is noted that FIG. 4 is intended to depict the representative major components of an exemplary computer system 400. In some embodiments, however, individual components may have greater or lesser complexity than as represented in FIG. 4, components other than or in addition to those shown in FIG. 4 may be present, and the number, type, and configuration of such components may vary.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method, comprising:
receiving an audio signal;
isolating a first audio stream of a first speaker from the audio signal;
identifying, based on the first audio stream, a first attribute of the first speaker;
presenting the first attribute to a user; and
modifying, based on the first audio stream and a user input, the first audio stream, resulting in a first modified audio stream.

2. The method of claim 1, further comprising:
isolating a second audio stream of a second speaker from the audio signal;
identifying, based on the second audio stream, a second attribute of the second speaker;
presenting the second attribute to a user; and
modifying, based on the second audio stream and the user input, the second audio stream.

3. The method of claim 1, further comprising modifying, based on the first modified audio stream, the audio signal.

4. The method of claim 1, wherein the attribute comprises a pitch of a voice of the first speaker.

5. The method of claim 1, wherein the attribute comprises a first language spoken by the first speaker.

6. The method of claim 5, wherein the identifying includes:
transcribing the audio stream, resulting in a transcription;
performing Natural Language Processing (NLP) on the transcription; and
identifying, based on the performing, the first language.

7. The method of claim 5, further comprising:
isolating a second audio stream of a second speaker from the audio signal;
identifying, based on the second audio stream, a second language spoken by the second speaker;
isolating an ambiguous audio stream of an unknown speaker from the audio signal; and
determining, based on the ambiguous audio stream, that the unknown speaker is speaking using the first language in the ambiguous audio stream.

8. The method of claim 7, further comprising identifying, based on the determining, that the unknown speaker is the first speaker.

9. The method of claim 1, further comprising providing, based on the first audio stream and the user input, subtitles, the subtitles based on the first audio stream.

10. A system comprising:
a memory; and
a central processing unit (CPU) coupled to the memory, the CPU configured to:
receive an audio signal;
isolate a first audio stream of a first speaker from the audio signal;
identify, based on the first audio stream, a first attribute of the first speaker;
present the first attribute to a user; and
modify, based on the first audio stream and a user input, the first audio stream, resulting in a first modified audio stream.

11. The system of claim 10, wherein the CPU is further configured to:
isolate a second audio stream of a second speaker from the audio signal;
identify, based on the second audio stream, a second attribute of the second speaker;
present the second attribute to a user; and
modify, based on the second audio stream and the user input, the second audio stream.

12. The system of claim 10, wherein the CPU is further configured to modify, based on the first modified audio stream, the audio signal.

13. The system of claim 10, wherein the attribute comprises a first language spoken by the first speaker.

14. The system of claim 13, wherein the identifying includes:
transcribing the audio stream, resulting in a transcription;
performing Natural Language Processing (NLP) on the transcription; and
identifying, based on the performing, the first language.

15. The system of claim 13, wherein the CPU is further configured to:
isolate a second audio stream of a second speaker from the audio signal;
identify, based on the second audio stream, a second language spoken by the second speaker;
isolate an ambiguous audio stream of an unknown speaker from the audio signal; and
determine, based on the ambiguous audio stream, that the unknown speaker is speaking using the first language in the ambiguous audio stream modify, based on the first modified audio stream, the audio signal.

16. A computer program product, the computer program product comprising a computer readable storage medium having program instructions embodied therewith, the program instructions executable by a computer to cause the computer to:
receive an audio signal;
isolate a first audio stream of a first speaker from the audio signal;
identify, based on the first audio stream, a first attribute of the first speaker;
present the first attribute to a user; and
modify, based on the first audio stream and a user input, the first audio stream, resulting in a first modified audio stream.

17. The computer program product of claim 16, wherein the instructions further cause the computer to:
isolate a second audio stream of a second speaker from the audio signal;
identify, based on the second audio stream, a second attribute of the second speaker;
present the second attribute to a user; and
modify, based on the second audio stream and the user input, the second audio stream.

18. The computer program product of claim 16, wherein the attribute comprises a first language spoken by the first speaker.

19. The computer program product of claim 18, wherein the identifying includes:
transcribing the audio stream, resulting in a transcription;
performing Natural Language Processing (NLP) on the transcription; and
identifying, based on the performing, the first language.

20. The computer program product of claim 18, wherein the instructions further cause the computer to:
isolate a second audio stream of a second speaker from the audio signal;
identify, based on the second audio stream, a second language spoken by the second speaker;
isolate an ambiguous audio stream of an unknown speaker from the audio signal; and
determine, based on the ambiguous audio stream, that the unknown speaker is speaking using the first language in the ambiguous audio stream modify, based on the first modified audio stream, the audio signal.
